(19) United States
(12) Patent Application Publication
(10) Pub. No.: US 2021/0144704 A1
(43) Pub. Date: May 13, 2021

(54) METHOD FOR ALLOCATING RESOURCES FOR MULTIPLE TRAFFIC TYPES IN WIRELESS COMMUNICATION SYSTEM SUPPORTING V2X AND APPARATUS THEREFOR

(71) Applicant: LG ELECTRONICS INC., Seoul (KR)

(72) Inventors: Myoungseob KIM, Seoul (KR); Hanbyul SEO, Seoul (KR)

(73) Assignee: LG ELECTRONICS INC., Seoul (KR)

(21) Appl. No.: 16/492,603

(22) PCT Filed: Mar. 7, 2018
(86) PCT No.: PCT/KR2018/002687

§ 371 Date: Sep. 9, 2019

Related U.S. Application Data
(60) Provisional application No. 62/468,379, filed on Mar. 8, 2017.

(51) Int. Cl. H04W 72/04; H04W 4/40

(52) U.S. Cl. CPC H04W 72/0446; H04W 4/40

(57) ABSTRACT

The present specification provides a method for resource allocation for multiple traffic types in a wireless communication system supporting vehicle-to-everything (V2X) communication. The resource allocation method, which is performed by a base station, comprises the steps of: setting a specific resource pool including at least one resource for each traffic type, wherein each of the plurality of traffic types differs in at least one of a transmission period and transmission time interval (TTI) length; and transmitting the set specific resource pool to a terminal corresponding to each traffic type, wherein the specific resource pool is set on the basis of the number of the traffic types and the longest set TTI length. Accordingly, the resource allocation method proposed in the present specification can provide efficiency in use of resources.

### TECHNICAL FIELD

The present invention relates to a wireless communication system supporting V2X, and more particularly, to a method for allocating resources for a plurality of traffic types, a method for transmitting and receiving traffic, and an apparatus for supporting the same.

### BACKGROUND ART

Mobile communication systems have been developed to provide voice services while ensuring the activity of a user. However, the mobile communication systems have been expanded to their regions up to data services as well as voice. Today, the shortage of resources is caused due to an explosive increase of traffic, and more advanced mobile communication systems are required due to user's need for higher speed services.

Requirements for a next-generation mobile communication system basically include the acceptance of explosive data traffic, a significant increase of a transfer rate per user, the acceptance of the number of significantly increased connection devices, very low end-to-end latency, and high energy efficiency. To this end, research is carried out on various technologies, such as dual connectivity, massive Multiple Input Multiple Output (MIMO), in-band full duplex, Non-Orthogonal Multiple Access (NOMA), the support of a super wideband, and device networking.

### DISCLOSURE

### Technical Problem

An object of the present disclosure is to provide a method for setting a resource pool for a plurality of traffic types having various types of transmission time interval (TTI) lengths and/or various types of transmission periods.

In addition, an object of the present disclosure is to provide a method for transmitting and receiving a plurality of traffic types between terminals in a wireless communication system supporting V2X.

Technical objects to be achieved in the present invention are not limited to the above-described technical objects, and other technical objects not described above may be evidently understood by a person having ordinary skill in the art to which the present invention pertains from the following description.

### Technical Solution

The present disclosure, in a method for resource allocation for traffic types in a wireless communication system supporting vehicle-to-everything (V2X) communication, the method performed by a base station, comprises the steps of: setting a specific resource pool including at least one resource for each traffic type, wherein each of the plurality of traffic types differs in at least one of a transmission period and transmission time interval (TTI) length; and transmitting the set specific resource pool to a terminal corresponding to each traffic type, wherein the specific resource pool may be set on the basis of the number of the plurality traffic types and the longest set TTI length.

Furthermore, the specific resource pool in the present disclosure may include a specific resource allocation unit to which TTIs of the same traffic type are contiguously allocated.

Furthermore, the specific resource allocation unit in the present disclosure may be the same as the set longest TTI length or is a multiple of the set longest TTI length.

Furthermore, when the transmission period of each of the plurality of traffic types is set differently, the specific resource pool in the present disclosure may be set in consideration of the transmission period of each traffic type.

Furthermore, the size of the specific resource pool in the present disclosure may be adjusted by a parameter determined according to the frequency of traffic transmission.

Furthermore, the size of the specific resource pool in the present disclosure may be the same as or greater than the total size of resources allocated to the plurality of traffic types.

Furthermore, the set information for the specific resource pool in the present disclosure may include at least one of size information of the specific resource pool, location information of the start and/or end of the specific resource pool, and information on the order of each traffic type in the specific resource pool.

Furthermore, the present disclosure, in a method for transmitting traffic in a wireless communication system supporting vehicle-to-everything (V2X) communication, the method performed by a first terminal, the method comprising the steps of: receiving a specific resource pool from a base station, wherein the specific resource pool is set to include at least one resource for each of a plurality of traffic types, and each of the plurality of traffic types differs in at least one of a transmission period or a transmission time interval (TTI) length; determining a resource for transmitting the traffic through sensing of the specific resource pool; and transmitting the traffic to a second terminal through the determined resource.

Furthermore, the present disclosure, in a first terminal for transmitting traffic in a wireless communication system supporting vehicle-to-everything (V2X) communication, comprising: a radio frequency (RF) module for transmitting and receiving a radio signal; a processor operably coupled to the RF module, wherein the processor configured to: control receiving a specific resource pool from a base station, wherein the specific resource pool is set to include at least one resource for each of a plurality of traffic types, and each of the plurality of traffic types differs in at least one of a transmission period or a transmission time interval (TTI) length; control determining a resource for transmitting the traffic through sensing of the specific resource pool; and control transmitting the traffic to a second terminal through the determined resource.

### Advantageous Effects

The present disclosure, by setting a resource pool for each traffic type according to the TTI length (or size) and/or (SPS) transmission period, has an effect that the resource may be efficiently used and the interference that can occur between terminals may be reduced.

Effects which may be obtained in the present invention are not limited to the above-described effects, and other technical effects not described above may be evidently understood by a person having ordinary skill in the art to which the present invention pertains from the following description.

### DESCRIPTION OF DRAWINGS

The accompanying drawings included as part of the detailed description in order to help understanding of the present invention provide embodiments of the present invention, and describe the technical characteristics of the present invention along with the detailed description.

FIG. 1 illustrates a structure a radio frame in a wireless communication system to which the present invention can be applied.

FIG. 2 is a diagram illustrating a resource grid for one downlink slot in the wireless communication system to which the present invention can be applied.

FIG. 3 illustrates a structure of a downlink subframe in the wireless communication system to which the present invention can be applied.

FIG. 4 illustrates a structure of an uplink subframe in the wireless communication system to which the present invention can be applied.

FIG. 5 is a diagram for describing elements of a D2D (device-to-device) communication technique.

FIG. 6 is a diagram illustrating an embodiment of a configuration of a resource unit.

FIG. 7 is a diagram illustrating an example of a resource pool setting method of data traffic having different transmission periods proposed in the present disclosure.

FIG. 8 is a diagram illustrating an example of a resource allocation method for each data traffic type proposed in the present disclosure.

FIG. 9 is a diagram illustrating an example of a resource allocation method for each data traffic type proposed in the present disclosure.

FIG. 10 is a diagram illustrating an example of a resource allocation method for each data traffic type having different TTI sizes and different SPS transmission periods proposed in the present disclosure.

FIG. 11 is a flowchart illustrating an example of an operation of a base station for implementing the method proposed in the specification.

FIG. 12 is a flowchart illustrating an example of a terminal operation for implementing a method proposed in the specification.

FIG. 13 illustrates a block diagram of a wireless communication device to which methods proposed in this specification may be applied.

FIG. 14 illustrates a block diagram of a communication device according to an embodiment of the present invention.

FIG. 15 is a diagram illustrating an example of an RF module of a wireless communication device to which a method proposed in this specification can be applied.

FIG. 16 is a diagram illustrating still another example of an RF module of a wireless communication device to which a method proposed in this specification can be applied.

### MODE FOR INVENTION

Hereinafter, preferred embodiments of the present invention will be described in detail with reference to the accompanying drawings. A detailed description to be disclosed below together with the accompanying drawing is to describe embodiments of the present invention and not to describe a unique embodiment for carrying out the present invention. The detailed description below includes details in order to provide a complete understanding. However, those skilled in the art know that the present invention can be carried out without the details.

In some cases, in order to prevent a concept of the present invention from being ambiguous, known structures and devices may be omitted or may be illustrated in a block diagram format based on core function of each structure and device.

In the specification, a base station means a terminal node of a network directly performing communication with a terminal. In the present document, specific operations described to be performed by the base station may be performed by an upper node of the base station in some cases. That is, it is apparent that in the network constituted by multiple network nodes including the base station, various operations performed for communication with the terminal may be performed by the base station or other network nodes other than the base station. A base station (BS) may be generally substituted with terms such as a fixed station, Node B, evolved-NodeB (eNB), a base transceiver system (BTS), an access point (AP), and the like. Further, a ‘terminal’ may be fixed or movable and be substituted with terms such as user equipment (UE), a mobile station (MS), a user terminal (UT), a mobile subscriber station (MSS), a subscriber station (SS), an advanced mobile station (AMS), a wireless terminal (WT), a Machine-Type Communication (MTC) device, a Machine-to-Machine (M2M) device, a Device-to-Device (D2D) device, and the like.

Hereinafter, a downlink means communication from the base station to the terminal and an uplink means communication from the terminal to the base station. In the downlink, a transmitter may be a part of the base station and a receiver may be a part of the terminal. In the uplink, the transmitter may be a part of the terminal and the receiver may be a part of the base station.

Specific terms used in the following description are provided to help appreciating the present invention and the use of the specific terms may be modified into other forms within the scope without departing from the technical spirit of the present invention.

The following technology may be used in various wireless access systems, such as code division multiple access (CDMA), frequency division multiple access (FDMA), time division multiple access (TDMA), orthogonal frequency division multiple access (OFDMA), single carrier-FDMA (SC-FDMA), non-orthogonal multiple access (NOMA), and the like. The CDMA may be implemented by radio technology universal terrestrial radio access (UTRA) or CDMA2000. The TDMA may be implemented by radio technology such as global system for mobile communications (GSM)/general packet radio service (GPRS)/enhanced data rates for GSM Evolution (EDGE). The OFDMA may be implemented as radio technology such as IEEE 802.11(Wi-Fi), IEEE 802.16 (WiMAX), IEEE 802-20, E-UTRA (Evolved UTRA), and the like. The UTRA is a part of a universal mobile telecommunication system (UMTS). 3rd generation partnership project (3GPP) long term evolution (LTE) as a part of an evolved UMTS (E-UMTS) using evolved-UMTS terrestrial radio access (E-UTRA) adopts the OFDMA in a downlink and the SC-FDMA in an uplink. LTE-advanced (A) is an evolution of the 3GPP LTE.

The embodiments of the present invention may be based on standard documents disclosed in at least one of IEEE 802, 3GPP, and 3GPP2 which are the wireless access systems. That is, steps or parts which are not described to definitely show the technical spirit of the present invention among the embodiments of the present invention may be based on the documents. Further, all terms disclosed in the document may be described by the standard document.

3GPP LTE/LTE-A is primarily described for clear description, but technical features of the present invention are not limited thereto.

General System

FIG. 1 Illustrates a Structure a Radio Frame in a Wireless Communication System to which the present invention can be applied.

In 3GPP LTE/LTE-A, radio frame structure type 1 may be applied to frequency division duplex (FDD) and radio frame structure type 2 may be applied to time division duplex (TDD) are supported.

In FIG. 1, the size of the radio frame in the time domain is represented by a multiple of a time unit of T_s=1/(15000*2048). The downlink and uplink transmissions are composed of radio frames having intervals of T_f=307200*T_s=10 ms.

FIG. 1(a) illustrates the type 1 radio frame structure. The type 1 radio frame may be applied to both full duplex FDD and half duplex FDD.

The radio frame includes 10 subframes. One radio frame includes 20 slots each having a length of T_slot=15360*T_s=0.5 ms. Indices 0 to 19 are assigned to the respective slots. One subframe includes two contiguous slots in the time domain, and a subframe i includes a slot 2i and a slot 2i+1. The time taken to send one subframe is called a transmission time interval (TTI). For example, the length of one subframe may be 1 ms, and the length of one slot may be 0.5 ms.

In FDD, uplink transmission and downlink transmission are classified in the frequency domain. There is no restriction to full duplex FDD, whereas a UE is unable to perform transmission and reception at the same time in a half duplex FDD operation.

One slot includes a plurality of orthogonal frequency division multiplexing (OFDM) symbols in the time domain and includes a plurality of resource blocks (RBs) in the frequency domain. An OFDM symbol is for expressing one symbol period because 3GPP LTE uses OFDMA in downlink. The OFDM symbol may also be called an SC-FDMA symbol or a symbol period. The resource block is a resource allocation unit and includes a plurality of contiguous subcarriers in one slot.

FIG. 1(b) illustrates the type 2 radio frame structure. The type 2 radio frame structure includes 2 half frames each having a length of 153600*T_s=5 ms. Each of the half frames includes 5 subframes each having a length of 30720*T_s=1 ms.

In the type 2 radio frame structure of a TDD system, an uplink-downlink configuration is a rule showing how uplink and downlink are allocated (or reserved) with respect to all of subframes. Table 1 represents the uplink-downlink configuration.

TABLE 1

| | Downlink- | |
|---|---|---|
| Uplink- | to-Uplink | |
| Downlink | Switch- | |
| config- | point | |
| uration | periodicity | Subframe number |
| 0 | 5 ms | |
| 1 | 5 ms | |
| 2 | 5 ms | |
| 3 | 10 ms | |
| 4 | 10 ms | |
| 5 | 10 ms | |
| 6 | 5 ms | |

Referring to Table 1, “D” indicates a subframe for downlink transmission, “U” indicates a subframe for uplink transmission, and “S” indicates a special subframe including the three fields of a downlink pilot time slot (DwPTS), a guard period (GP), and an uplink pilot time slot (UpPTS) for each of the subframes of the radio frame.

The DwPTS is used for initial cell search, synchronization or channel estimation by a UE. The UpPTS is used for an eNB to perform channel estimation and for a UE to perform uplink transmission synchronization. The GP is an interval for removing interference occurring in uplink due to the multi-path delay of a downlink signal between uplink and downlink.

Each subframe i includes the slot 2i and the slot 2i+1 each having “T_slot=15360*T_s=0.5 ms.”

The uplink-downlink configuration may be divided into seven types. The location and/or number of downlink subframes, special subframes, and uplink subframes are different in the seven types.

A point of time changed from downlink to uplink or a point of time changed from uplink to downlink is called a switching point. Switch-point periodicity means a cycle in which a form in which an uplink subframe and a downlink subframe switch is repeated in the same manner. The switch-point periodicity supports both 5 ms and 10 ms. In the case of a cycle of the 5 ms downlink-uplink switching point, the special subframe S is present in each half frame. In the case of the cycle of the 5 ms downlink-uplink switching point, the special subframe S is present only in the first half frame.

In all of the seven configurations, No. 0 and No. 5 subframes and DwPTSs are an interval for only downlink transmission. The UpPTSs, the subframes, and a subframe subsequent to the subframes are always an interval for uplink transmission.

Both an eNB and a UE may be aware of such uplink-downlink configurations as system information. The eNB may notify the UE of a change in the uplink-downlink allocation state of a radio frame by sending only the index of configuration information whenever uplink-downlink configuration information is changed. Furthermore, the configuration information is a kind of downlink control information. Like scheduling information, the configuration information may be transmitted through a physical downlink control channel (PDCCH) and may be transmitted to all of UEs within a cell in common through a broadcast channel as broadcast information.

Table 2 represents a configuration (i.e., the length of a DwPTS/GP/UpPTS) of the special subframe.

TABLE 2

| | Normal cyclic prefix in | | | Extended cyclic prefix in | | |
|---|---|---|---|---|---|---|
| | downlink | | | downlink | | |
| Special | | UpPTS | | | UpPTS | |
| subframe | | Normal cyclic | Extended cyclic | | Normal cyclic | Extended cyclic |
| configuration | DwPTS | prefix in uplink | prefix in uplink | DwPTS | prefix in uplink | prefix in uplink |
| 0 | 6592 | 219 [symbol] | 2560 · [symbol] | 7680 | 219 [symbol] | 2560 · [symbol] |
| 1 | 1976 [symbol] | | | 2048 | | |
| 2 | 2195 | | | 2304 | | |
| 3 | 2414 | | | 2560 | | |
| 4 | 2633 | | | 7680 | 438 [symbol] | 5120 · [symbol] |
| 5 | 6592 | 438 [symbol] | 5120 · [symbol] | 2048 | | |
| 6 | 1976 | | | 2304 | | |
| 7 | 2195 | | | — | — | — |
| 8 | 2414 | | | — | — | — |

[symbol]

indicates data missing or illegible when filed

The structure of the radio frame according to the example of FIG. 1 is only one example. The number of subcarriers included in one radio frame, the number of slots included in one subframe, and the number of OFDM symbols included in one slot may be changed in various manners.

FIG. 2 is a diagram illustrating a resource grid for one downlink slot in the wireless communication system to which the present invention can be applied.

Referring to FIG. 2, one downlink slot includes the plurality of OFDM symbols in the time domain. Herein, it is exemplarily described that one downlink slot includes 7 OFDM symbols and one resource block includes 12 subcarriers in the frequency domain, but the present invention is not limited thereto.

Each element on the resource grid is referred to as a resource element and one resource block includes 12×7 resource elements. The number of resource blocks included in the downlink slot, NDL is subordinated to a downlink transmission bandwidth.

A structure of the uplink slot may be the same as that of the downlink slot.

FIG. 3 illustrates a structure of a downlink subframe in the wireless communication system to which the present invention can be applied.

Referring to FIG. 3, a maximum of three former OFDM symbols in the first slot of the sub frame is a control region to which control channels are allocated and residual OFDM symbols is a data region to which a physical downlink shared channel (PDSCH) is allocated. Examples of the downlink control channel used in the 3GPP LTE include a Physical Control Format Indicator Channel (PCFICH), a Physical Downlink Control Channel (PDCCH), a Physical Hybrid-ARQ Indicator Channel (PHICH), and the like.

The PFCICH is transmitted in the first OFDM symbol of the subframe and transports information on the number (that is, the size of the control region) of OFDM symbols used for transmitting the control channels in the subframe. The PHICH which is a response channel to the uplink transports an Acknowledgement (ACK)/Not-Acknowledgement (NACK) signal for a hybrid automatic repeat request (HARQ). Control information transmitted through a PDCCH is referred to as downlink control information (DCI). The downlink control information includes uplink resource allocation information, downlink resource allocation information, or an uplink transmission (Tx) power control command for a predetermined terminal group.

The PDCCH may transport A resource allocation and transmission format (also referred to as a downlink grant) of a downlink shared channel (DL-SCH), resource allocation information (also referred to as an uplink grant) of an uplink shared channel (UL-SCH), paging information in a paging channel (PCH), system information in the DL-SCH, resource allocation for an upper-layer control message such as a random access response transmitted in the PDSCH, an aggregate of transmission power control commands for individual terminals in the predetermined terminal group, a voice over IP (VoIP). A plurality of PDCCHs may be transmitted in the control region and the terminal may monitor the plurality of PDCCHs. The PDCCH is constituted by one or an aggregate of a plurality of continuous control channel elements (CCEs). The CCE is a logical allocation wise used to provide a coding rate depending on a state of a radio channel to the PDCCH. The CCEs correspond to a plurality of resource element groups. A format of the PDCCH and a bit number of usable PDCCH are determined according to an association between the number of CCEs and the coding rate provided by the CCEs.

The base station determines the PDCCH format according to the DCI to be transmitted and attaches the control information to a cyclic redundancy check (CRC) to the control information. The CRC is masked with a unique identifier (referred to as a radio network temporary identifier (RNTI)) according to an owner or a purpose of the PDCCH. In the case of a PDCCH for a specific terminal, the unique identifier of the terminal, for example, a cell-RNTI (C-RNTI) may be masked with the CRC. Alternatively, in the case of a PDCCH for the paging message, a paging indication identifier, for example, the CRC may be masked with a paging-RNTI (P-RNTI). In the case of a PDCCH for the system information, in more detail, a system information block (SIB), the CRC may be masked with a system information identifier, that is, a system information (SI)-RNTI. The CRC may be masked with a random access (RA)-RNTI in order to indicate the random access response which is a response to transmission of a random access preamble.

Enhanced PDCCH (EPDCCH) carries UE-specific signaling. The EPDCCH is located in a physical resource block (PRB) that is set to be terminal specific. In other words, as described above, the PDCCH may be transmitted in up to three OFDM symbols in the first slot in the subframe, but the EPDCCH may be transmitted in a resource region other than the PDCCH. The time (i.e., symbol) at which the EPDCCH in the subframe starts may be set in the UE through higher layer signaling (e.g., RRC signaling, etc.).

The EPDCCH is a transport format, a resource allocation and HARQ information associated with the DL-SCH and a transport format, a resource allocation and HARQ information associated with the UL-SCH, and resource allocation information associated with SL-SCH (Sidelink Shared Channel) and PSCCH Information, and so on. Multiple EPDCCHs may be supported and the terminal may monitor the set of EPCCHs.

The EPDCCH may be transmitted using one or more successive advanced CCEs (ECCEs), and the number of ECCEs per EPDCCH may be determined for each EPDCCH format.

Each ECCE may be composed of a plurality of enhanced resource element groups (EREGs). EREG is used to define the mapping of ECCE to RE. There are 16 EREGs per PRB pair. All REs are numbered from 0 to 15 in the order in which the frequency increases, except for the RE that carries the DMRS in each PRB pair.

The UE may monitor a plurality of EPDCCHs. For example, one or two EPDCCH sets may be set in one PRB pair in which the terminal monitors the EPDCCH transmission.

Different coding rates may be realized for the EPOCH by merging different numbers of ECCEs. The EPOCH may use localized transmission or distributed transmission, which may result in different mapping of the ECCE to the REs in the PRB.

FIG. 4 illustrates a structure of an uplink subframe in the wireless communication system to which the present invention can be applied.

Referring to FIG. 4, the uplink subframe may be divided into the control region and the data region in a frequency domain. A physical uplink control channel (PUCCH) transporting uplink control information is allocated to the control region. A physical uplink shared channel (PUSCH) transporting user data is allocated to the data region. One terminal does not simultaneously transmit the PUCCH and the PUSCH in order to maintain a single carrier characteristic.

A resource block (RB) pair in the subframe are allocated to the PUCCH for one terminal. RBs included in the RB pair occupy different subcarriers in two slots, respectively. The RB pair allocated to the PUCCH is frequency-hopped in a slot boundary.

D2D (Device-to-Device) Communication

FIG. 5 is a diagram for describing elements of a D2D (device-to-device) communication technique.

In FIG. 5, a UE means a terminal of a user, but when network equipment such as an eNB transmits and receives a signal according to a communication method with the UE, the corresponding network equipment may also be regarded as a kind of UE. Hereinafter, UE1 may operate to select a resource unit corresponding to a specific resource in a resource pool representing a set of resources and transmit a D2D signal using the corresponding resource unit. UE2, which is a receiving UE, configures a resource pool through which UE1 can transmit a signal, and detects a signal of UE1 within the corresponding pool. Here, the resource pool may be informed by the base station when UE1 is in the connection range of the base station, and may be determined by another UE or determined as a predetermined resource when it is outside the connection range of the base station. In general, a resource pool may include a plurality of resource units, and each UE may select one or a plurality of resource units to use for transmitting their D2D signals.

FIG. 6 is a diagram illustrating an embodiment of a configuration of a resource unit.

Referring to FIG. 6, a total frequency resource is divided into N_F and a total time resource is divided into N_T, so that the total number of N_F*N_T resource units may be defined. In this case, it can be expressed that the resource pool is repeated every N_T subframes. Specifically, one resource unit may be expressed periodically and repeatedly as shown in the figure. Alternatively, in order to obtain a diversity effect in a time or frequency dimension, an index of a physical resource unit to which one logical resource unit is mapped may change in a predetermined pattern according to time. In this resource unit structure, a resource pool may mean a set of resource units that can be used for transmission by a UE that intends to transmit a D2D signal.

The resource pool described above may be subdivided into several types. First, resource pools may be classified according to contents of D2D signals transmitted from each resource pool. As an example, the contents of the D2D signal may be classified as follows, and a separate resource pool may be configured, respectively.

Scheduling assignment (SA): A signal containing information such as a location of a resource for a transmission of a D2D data channel performed by each transmitting UE, a modulation and coding scheme (MCS), or MIMO transmission method, and/or timing advance required for demodulation of other data channels. This signal may be multiplexed and transmitted together with D2D data on the same resource unit, and the SA resource pool in the present disclosure may mean a pool of resources transmitted by multiplexing the SA with D2D data, and another name may be called a D2D control channel.

D2D data channel: A resource pool used by a transmitting UE to transmit user data using resources specified through SA. When it is possible to transmit multiplexed data with D2D data on the same resource unit, the resource pool for the D2D data channel may be a form in which only the D2D data channel having the form except for the SA information is transmitted. In other words, the resource elements used to transmit SA information on individual resource units in the SA resource pool may still be used to transmit D2D data in the D2D data channel resource pool.

Discovery channel: The resource pool for a message that allows a transmitting UE to transmit information, such as its ID, so that a neighboring UE can discover the transmitting UE itself.

Contrary to the above case, even when the content of the D2D signal is the same as each other, different resource pools may be used according to the transmission/reception attributes of the D2D signal. As an example, even in the same D2D data channel or discovery message, based on a transmission timing determination method of a D2D signal (for example, whether it is transmitted at the time of receiving a synchronization reference signal or is transmitted by applying a constant timing advance from the time) or a resource allocation method (for example, whether the eNB assigns transmission resources of an individual signal to an individual transmitting UE or whether an individual transmitting UE selects an individual signaling resource on its own within a pool), a signal format (for example, the number of symbol of each D2D signal occupies in one subframe, or the number of subframes used to transmit one D2D signal), signal strength from eNB, and transmit power strength of the D2D UE, it may be again divided into different resource pools.

In the present disclosure, for convenience of explanation, in D2D or V2V communication, a method in which eNB directly indicates transmission resources of D2D transmitting UE is called/defined as Mode 1 or Mode 3 and a method in which the transmission resource region is set in advance or the eNB assigns the transmission resource region and the UE directly selects the transmission resource is called/defined as ode 2 or Mode 4. In case of D2D discovery, the case that the eNB directly indicates a resource is called/defined as Type 2 and the case that a UE directly selects a transmission resource in a predetermined resource region or a resource region indicated by the eNB is called/defined as Type 1.

The above-mentioned D2D may be called sidelink, and SA may be called as a physical sidelink control channel (PSCCH), a D2D synchronization signal may be called as a sidelink synchronization signal (SSS), and a control channel that transmits the most basic information before D2D communication and transmitted with SSS may be called a physical sidelink broadcast channel (PSBCH), or another name, a PD2DSCH (Physical D2D synchronization channel). A signal for notifying that a specific terminal is in the vicinity thereof, in which case the signal may include an ID of the specific terminal, and this channel may be called a physical sidelink discovery channel (PSDCH).

In Rel. 12 D2D, only the D2D communication UE transmits the PSBCH together with the SSS, and thus the measurement of the SSS is performed by using the DMRS of the PSBCH. The out-coverage UE measures the DMRS of the PSBCH and measures the reference signal RSRP (reference signal received power) of this DMRS to determine whether the UE itself is to be a synchronization source.

In the next generation communication system, such as 5G, requiring low latency, data may be transmitted using a shorter transmission period (i.e. short TTI) than the transmission period (or transmission time interval, i.e. normal TTI) used in the existing communication system (e.g. LTE).

In particular, in a vehicle communication system such as vehicle-to-everything (V2X) that requires a quick response speed, the concept of short transmission time such a short TTI may be introduced in the future in order to reduce the latency in transmission and transmit the message related to the safety of the vehicle and the driver quickly.

However, the vehicle terminal or the driver terminal of all vehicles may not necessarily be equipped with the latest functions, and the legacy terminal and the advanced terminal may be existed to be mixed.

In addition, when the data transmission method is the SPS (Semi-Persistent-Scheduling) transmission method, packets having different TTIs as well as packets having the same TTI may have different transmission periods.

Here, the term the ‘function of the terminal’ may mean, for example, whether a corresponding terminal can support a short transmission period.

For example, it is assumed that the length of an existing transmission period is called 1 ms, this is called ‘TTI type A’, and the length of the short transmission period is called 0.5 ms, and this is called ‘TTI type B’.

UEs of TTI type A will perform the operation of sensing and the like by performing measurements in units of 1 ms to find resources for transmitting data.

In this case, even if the UE(s) of the TTI type B occupies only for 0.5 ms within a specific 1 ms period, the UEs of TTI type A may be recognized that all resources (specific 1 ms period) of the corresponding periods are in use or are being occupied.

For example, when the received power (e.g. RSRP) of the specific resource is less than X dBm, it is assumed that the specific resource can be considered as a candidate resource that can be used for data transmission.

When the RSRP of a signal transmitted by a specific UE of TTI type B in a specific resource is larger than (X+3) dBm for 0.5 ms, the overall RSRP for 1 ms in the corresponding resource is larger than X dBm.

In addition, since UEs having a TTI type B have a short TTI period, data is to be transmitted more frequently if the average power consumption (per hour) is assumed to be the same as that of the UE having a TTI type A.

Alternatively, in the case of the SPS transmission scheme, transmission periods of UEs having a TTI type B may be shorter. In this case, as described above, the case that the UEs of TTI type A fail to select resources occurs more frequently. In this case, as described above, the case that the UEs of TTI type A fail to select resources is to occur more frequently.

Also, on the contrary, when the RSRP of a signal transmitted by a specific UE having a TTI type B in a specific resource is less than (X+3) dBm (greater than X) for 0.5 ms, although the UE (of TTI type B) may give a considerable amount of interference (at least for 0.5 ms interval) to the UE of TTI type A, the UE of TTI type A may select the specific resource.

Therefore, the present disclosure provides, for supporting low latency and efficiency of resource selection (of the UE), a method of setting different resource pools that can be selected by the UEs of different types (e.g. different TTI sizes and/or different transmission periods).

Hereinafter, a method of setting a resource pool for various types of terminals proposed in the present specification will be described in detail.

The resource setting method for various types of terminals proposed in the present specification includes (1) a resource pool setting method according to an SPS transmission period (first embodiment) and (2) a resource pool setting method according to a TTI size (second embodiment), and the above methods (1) and (2) may be used in combination.

### First Embodiment

The first embodiment shows a method of setting a resource pool depending on an SPS transmission period.

It is assumed that data packets have different (SPS) transmission periods depending on the type of data traffic transmitted by a vehicle communication system such as V2X.

In this case, the kind (or type) of data traffic may be expressed in such as t_0, t_1, . . . , t (k−1). Here, k represents the number of data traffic types.

Further, when each data traffic type has a different SPS transmission period, the SPS transmission periods of each data traffic type may be expressed in such as P_0, P_1, . . . , P_(k−1) (unit: ms).

In addition, for convenience of description, when i≥j, it is assumed that P_i≥P_j.

Here, i and j satisfy (k−1)≥i≥0 and (k−1)≥j≥0, respectively.

Also, when the greatest common divisor (GCD) of P_0, P_1, . . . , P_(k−1) is ‘P_0/m’, the data traffic (t_0, t_1, . . . , t_(k−1)) can be designed as shown in FIG. 3-x so that all of them can have one or more transmission opportunities in a mini window of the form P_0/m or P_0/(m*n).

For example, when P_0=10, P_1=20, P_2=40, the greatest common divisor is 10/1 and m=1.

In addition, n represents a parameter for adjusting the size of the mini-window, when it is necessary to increase the transmission (or generation) frequency of data traffic.

Here, m and n are positive integers.

In addition, the mini window is a resource interval that allows all data traffic to be transmitted at least once, and may be a unit of a resource pool scheduled by the base station.

In addition, the base station may repeatedly allocate resources to the terminal in units of mini windows.

That is, when a specific resource pool is repeated, the specific resource pool should include all data traffic types.

In this case, for the size of the resource pool, the greatest common divisor of P_0, P_1, . . . , P_(k−1) or the value that the greatest common divisor is divided by an integer may be preferable. That is, the size of the resource pool can be defined as in Equation 1 below.

GCD(P_0,P_1, . . . ,P_(k−1))=min(P_0,P_1, . . . ,P_(k−1))/m [Equation 1]

When min (P_0, P_1, . . . , P_(k−1))=P_0, it may be expressed as GCD (P_0, P_1, . . . , P_(k−1))=P_0/m.

In this case, the size of the preferred resource pool may be in the form of P_0/(m*n).

The size of the resource pool may be interpreted to be the same as the size of the above-mentioned mini window.

That is, the resource pool or mini window may include spaces (or resources) through which various types of traffic or various TTI types of data can be transmitted.

The corresponding data may be transmitted from all resources or some resources of the resource pool (or mini window).

FIG. 7 is a diagram illustrating an example of a resource pool setting method of data traffic having different transmission periods proposed in the present disclosure.

In FIG. 7, it may be seen that data traffic having four different transmission periods exists, and the size of the mini window size is P_0/2.

In addition, the hatched portion in FIG. 7 represents the number of resources allocated in the mini window size for each of data traffic.

In FIG. 7, it may be seen that the size of TTI for each data traffic is the same as each other, and 1, 2, 3, and 4 resources are allocated to t_0, t_1, t_2, and t_3 in the mini window, respectively.

Here, when the TTI sizes of packets transmitting data traffic (t_0, t_1, . . . , t_(k−1)) are defined s_0, s_1, . . . , s_(k−1), respectively, the mini window size may be defined as in Equations 2 and 3 below.

P_0/(m*n)÷Σᵢ₌₀^{k 1}(lᵢ·sᵢ) [Equation 2]

Here, t_i is the number of resources allocated to the mini window. More preferably, the mini window size may be defined as in Equation 3.

P_0/(m*n)=X*Σᵢ₌₀^{k-1}(lᵢ·sᵢ) [Equation 3]

That is, when the mini window size satisfies Equation 3, resource allocation to UEs may be easier.

For example, it is assumed that five data traffic types are defined as shown in Table 3.

In Table 3, since each (SPS) transmission period for each traffic type is given in 10, 20, 30, 50, 100 ms, the size of the mini window may be expressed in the form of 10/m (ms).

In the 10/m, ‘10’ is the smallest transmission period (P_0) value.

Table 3 is a table showing an example of data traffic types having the same TTI length and having different transmission periods.

TABLE 3

| Traffic type | SPS period | TTI length |
|---|---|---|
| t_0 | 10 ms | 1 ms |
| t_1 | 20 ms | 1 ms |
| t_2 | 30 ms | 1 ms |
| t_3 | 50 ms | 1 ms |
| t_4 | 100 ms | 1 ms |

Here, when m=1, that is, the size of the mini window is 10 ms, each (data) traffic type may be transmitted twice in one mini window.

In order for five data traffic types to transmit data evenly for 10 ms, each (data) traffic type is to be transmitted twice.

FIG. 8 is a diagram illustrating an example of a resource allocation method for each data traffic type proposed in the present disclosure.

Specifically, FIG. 8A shows that two resources are allocated in adjacent manner for each (data) traffic type and FIG. 8B shows that each traffic type are allocated once for 5 ms and then repeatedly allocated for the remaining 5 ms.

The resource allocation method of FIG. 8B may be the same resource allocation method as when m=2, that is, i.e. when the mini window size is 5 ms.

FIG. 8C corresponds to a resource allocation method in which the traffic types appropriately (or arbitrarily) mix the allocation types required by each traffic type, such as a consecutive allocation method and an uniform allocation method in consideration of a latency requirement.

In addition, since the data traffic type is given as in Table 4 differently from Table 3, the case that the mini-window is not evenly allocated to the given traffic types as shown in FIG. 9 (a) may be occurred.

In this case, as shown in FIG. 9 (b), the remaining resource 921 is set as a common resource (contention-based or sensing-based allocation, etc.) to enable transmission of all traffic types, or it may be set to use as a component of a resource pool for fall-back mode, or it may be set to use for transmission of control channels.

Alternatively, as shown in FIG. 9C, the remaining resource 931 may be allocated more for a specific traffic type (t_2, t_3).

Table 4 shows another example of data traffic types having different periods.

TABLE 4

| Traffic type | SPS period | TTI length |
|---|---|---|
| t_0 | 10 ms | 1 ms |
| t_1 | 20 ms | 1 ms |
| t_2 | 50 ms | 1 ms |
| t_3 | 100 ms | 1 ms |

### Second Embodiment

The second embodiment shows a method of setting a resource pool depending on the TTI size.

It may be advantageous in terms of resource efficiency to allocate resources as closely as possible between UEs having short TTIs in order to minimize the influence between packets having different TTIs.

In this case, the minimum unit of such consecutive resource allocation may be set to match the normal TTI (e.g. 1 ms) size, or preferably the largest TTI (e.g. 1 ms) size (on a given system).

In the following Table 5, the minimum unit of the adjacent resource allocation is 2 ms.

That is, in Equation 1 or 2, lᵢ·sᵢ may be 2 ms or a multiple of 2 ms.

Accordingly, the size of the mini window may be in the form of 10 ms or a divisor of 10 ms, and since the largest TTI is 2 ms, it may be preferable to determine the mini window size as 10 ms.

In addition, since the sum of lᵢ·sᵢ for the five traffic types in Table 5 is 10 ms, it is also not appropriate that the size of the mini window is less than 10 ms.

Therefore, the size of the mini window can be generalized as shown in Equation 4 below.

P_0/(m*n)=Y*max(sᵢ) [Equation 4]

That is, when the size of a specific mini window (or a specific resource pool) is in the form of Equation 5 below,

GCD(P_0,P_1, . . . ,P_(k−1))/n=min(P_0,P_1, . . . ,P_(k−1))/(m*n)=P_0/(m*n) [Equation 5]

The resource pool (or mini window) of P_0/(m*n) should include all types of traffic and/or TTIs.

In addition, as described above, each TTI type may be preferably adjacent to each other.

Thus, the size of the configured TTI group may preferably be in the form of the size of the largest TTI or a multiple thereof (e.g., q times) (when the size of the largest TTI becomes a multiple of the remaining TTIs).

Here, the TTI group may represent the hatched portion 1010 for each traffic type, as shown in FIG. 10.

That is, when the TTI size for each traffic type is s_0, s_1, . . . , s_(k−1), the minimum consecutive resource allocation unit of same type of TTIs of FIG. 10 may be expressed in such as q*max(s_0, s_1, . . . , s_(k−1)).

The minimum consecutive resource allocation unit of the same type of TTIs may be represented by a TTI group or the like.

Or, more precisely, the minimum consecutive resource allocation unit may be in the form of a multiple of the least common multiple for existing TTIs.

When there are k traffic types and for each TTI type, only one of the minimum consecutive resource allocation units occupies in the mini window, the relationship between the size of the mini window (or resource pool) and the size of the TTI may be defined as Equation 6.

P_0/(m*n)=kl*LCM(s_0,s_1, . . . ,s_(k−1))=k*(q*max(s_0,s_1, . . . ,s_(k−1)))=(k*q)*max(s_i)=Y*max(s_i) [Equation 6]

Here, LCM represents the least common multiple.

In Equation 6, Y may be a form of multiplying the number (k) of the traffic (or TTI type) type by a specific integer value (q, q=1 in Table 5 and FIG. 10).

Alternatively, since each TTI type may have a different resource pool interval, Y may be defined as in Equation 7.

Y=Σᵢ₌₀^{k-1}qᵢ [Equation 7]

Here, qᵢ may be used as a parameter representing the ratio of the interval in which the resource pool for each TTI type (i.e., t_i) occupies in the mini window, and the length of the resource pool for a specific TTI type (i.e., t_i) means to be qᵢ times of the length of the TTI interval.

In this case, the resource pool (or mini window) of FIGS. 7 to 10 should be configured to which type of TTI can use the resource at which position.

For example, as shown in FIG. 7, all positions of resource candidates to which respective TTI data can be transmitted should be assigned (e.g. in a bitmap format).

Alternatively, in the case of FIG. 10, in a situation in which a start position and a last position of a resource pool (or mini window) are given (or configured), the information on the total number of TTI types and the size of resources occupied by each TTI group (i.e., minimum consecutive resource allocation unit), the specific TTI is in which number of order in the resource pool, and the like should be additionally configured.

Table 5 shows another example of traffic types having different TTI sizes.

TABLE 5

| | | |
|---|---|---|
| Traffic type | TTI length | SPS period |

| | | | |
|---|---|---|---|
| t_0 | 0.25 | ms | 10 ms |
| t_1 | 0.333 | ms | 30 ms |
| t_2 | 0.5 | ms | 50 ms |
| t_3 | 1 | ms | 100 ms |
| t_4 | 2 | ms | 200 ms |

FIG. 10 is a diagram illustrating an example of a resource allocation method for a traffic type having different sizes of TTIs and different SPS transmission periods proposed in the present disclosure.

As illustrated, in FIG. 10, the TTIs of each traffic type are different from each other, and the size of the TTI group (minimum continuous resource allocation unit) is 2 ms, which is the TTI size of t_4 having the largest TTI size.

It may be seen that there are 8, 6, 4, 2 and 1 TTI (s) in the TTI groups of t_0, t_1, t_2, t_3 and t_4, respectively.

In addition, in the above-described resource allocation methods, in transmitting data of various traffic types having different sizes of TTIs and different SPS transmission periods, the method of reducing the interference between traffic types and efficiently using resources is proposed.

Therefore, data transmission for each traffic type is not necessarily transmitted only in the locations of FIGS. 7 to 10.

For example, when the priority (PPPP) of a specific packet is greater than or equal to a predetermined threshold, the UE may perform sensing, data transmission and the like on a resource of another traffic type through sensing or the like.

However, when different traffic types have the same priority (PPPP), it may be used for data transmission for the traffic type originally assigned to a specific resource.

FIG. 11 is a flowchart illustrating an example of an operation of a base station for implementing the method proposed in the specification.

FIG. 11 shows a method of allocating resources for a plurality of traffic types in a wireless communication system supporting vehicle-to-everything (V2X) communication.

First, the base station sets a specific resource pool to include at least one resource for each traffic type (S1110).

The specific resource pool may be set based on the number of the plurality of traffic types and the longest set TTI length.

When the transmission period of each traffic type is set differently, the specific resource pool may be set in consideration of the transmission period of each traffic type.

In addition, the size of the specific resource pool may be adjusted by a parameter determined according to the frequency of traffic transmission, and the above-mentioned value of n may correspond to the parameter.

In addition, the size of the specific resource pool may be equal to or larger than the total size of resources allocated to the plurality of traffic types.

In addition, the specific resource pool may include a specific resource allocation unit to which TTIs of the same traffic type are consecutively allocated.

The specific resource allocation unit may be equal to the longest set TTI length or a multiple of the longest set TTI length.

Here, for each of the plurality of traffic types, at least one of a transmission period or a transmission time interval (TTI) length may be different from each other.

Thereafter, the base station may transmit the set specific resource pool to each terminal corresponding to each traffic type (S1120).

When the specific resource pool is not predetermined, the base station may transmit configuration information on the specific resource pool to the terminal. In this case, the configuration information on the specific resource pool may include at least one of size information of the specific resource pool, location information of the start and/or end of the specific resource pool, and information on the order of each traffic type in the specific resource pool.

FIG. 12 is a flowchart illustrating an example of a terminal operation for implementing a method proposed in the specification.

In FIG. 12, a first terminal and a second terminal may refer to a terminal that transmits and receives V2X data.

Alternatively, the first terminal may mean a V2X transmitting terminal, and the second terminal may mean a V2X receiving terminal.

First, the first terminal receives a specific resource pool from the base station (S1210).

The specific resource pool may be configured to include at least one resource for each of a plurality of traffic types.

In addition, the plurality of traffic types may have at least one of a transmission period or a transmission time interval (TTI) length, respectively.

Thereafter, the first terminal determines a resource for transmitting the traffic by sensing the specific resource pool (S1220).

Thereafter, the first terminal transmits the traffic to the second terminal through the determined resource (S1230).

Descriptions other than the base station operation of FIG. 11 may be equally applicable to FIG. 12.

### General Apparatus to which the Present Invention May be Applied

FIG. 13 illustrates a block diagram of a wireless communication device to which methods proposed in this specification may be applied.

Referring to FIG. 13, the wireless communication system includes an eNB 1310 and multiple UEs 1320 located with the area of the eNB 1310.

The eNB 1310 includes a processor 1311, memory 1312 and a radio frequency (RF) unit 1313. The processor 1311 implements the functions, processes and/or methods proposed in FIGS. 1 to 12. The layers of a radio interface protocol may be implemented by the processor 1311. The memory 1312 is connected to the processor 1311 and stores a variety of types of information for driving the processor 1311. The RF unit 1313 is connected to the processor 1311 and transmits and/or receives radio signals.

The RF unit may be called as a RF unit or a RF module.

The UE 1320 includes a processor 1321, memory 1322 and an RF unit 1323

The processor 1321 implements the functions, processes and/or methods proposed in FIGS. 1 to 12. The layers of a radio interface protocol may be implemented by the processor 1321. The memory 1322 is connected to the processor 1321 and stores a variety of types of information for driving the processor 1321. The RF unit 1323 is connected to the processor 1321 and transmits and/or receives radio signals.

The memory 1312, 1322 may be positioned inside or outside the processor 1311, 1321 and may be connected to the processor 1311, 1321 by various well-known means. Furthermore, the eNB 1310 and/or the UE 1320 may have a single antenna or multiple antennas.

In addition, the base station and/or the UE may have a single antenna or multiple antennas.

FIG. 14 illustrates a block diagram of a communication device according to an embodiment of the present invention.

Specifically, FIG. 14 is a diagram illustrating the UE of FIG. 13 more specifically.

Referring to FIG. 14, the UE may include a processor (or digital signal processor (DSP)) 1410, an RF module (or RF unit) 1435, a power management module 1405, an antenna 1440, a battery 1455, a display 1415, a keypad 1420, a memory 1430, a subscriber identification module (SIM) card 1425 (this element is optional), a speaker 1445, and a microphone 1450. The UE may further include a single antenna or multiple antennas.

The processor 1410 implements the functions, processes and/or methods proposed in FIGS. 1 to 12. The layers of a radio interface protocol may be implemented by the processor.

The memory 1430 is connected to the processor 1410, and stores information related to the operation of the processor 1410. The memory may be positioned inside or outside the processor 1410 and may be connected to the processor 1410 by various well-known means.

A user inputs command information, such as a telephone number, by pressing (or touching) a button of the keypad 1420 or through voice activation using the microphone 1450, for example. The processor receives such command information and performs processing so that a proper function, such as making a phone call to the telephone number, is performed. Operational data may be extracted from the SIM card 1425 or the memory. Furthermore, the processor 1410 may recognize and display command information or driving information on the display 1415, for convenience sake.

The RF module 1435 is connected to the processor 1410 and transmits and/or receives RF signals. The processor delivers command information to the RF module 1435 so that the RF module 1435 transmits a radio signal that forms voice communication data, for example, in order to initiate communication. The RF module 1435 includes a receiver and a transmitter in order to receive and transmit radio signals. The antenna 1440 functions to transmit and receive radio signals. When a radio signal is received, the RF module 1435 delivers the radio signal so that it is processed by the processor 1410, and may convert the signal into a baseband. The processed signal may be converted into audible or readable information output through the speaker 1445.

FIG. 15 is a diagram illustrating an example of an RF module of a wireless communication device to which a method proposed in this specification can be applied.

Specifically, FIG. 15 illustrates an example of an RF module that may be implemented in a frequency division duplex (FDD) system.

First, in the transmission path, the processor described in FIGS. 13 and 14 processes the data to be transmitted and provides an analog output signal to the transmitter 1510.

Within transmitter 1510, the analog output signal is filtered by a low pass filter (LPF) 1511 to remove images caused by digital-to-analog conversion (ADC), is up-converted from a base band to a RF band by a up-conversion mixer 1512, is amplified by Variable Gain Amplifier (VGA) 1513, and the amplified signal is filtered by a filter 1514, and is further amplified by a power amplifier (PA) 1515, is routed through duplexer(s) 1550/antenna switch(es) 1560, and is transmitted via antenna 1570.

Also, in the receive path, antenna 1570 receives signals from the outside and provides the received signals, which are routed through antenna switch(es) 1560/duplexers 1550 and is provided to the receiver 1520

Within the receiver 1520, the received signals are amplified by a low noise amplifier (LNA) 1523, are filtered by a band-pass filter 1524, and are down-converted from the RF band to a baseband by a down conversion mixer 1525.

The down-converted signal is filtered by a low pass filter (LPF) 1526 and is amplified by VGA 1527 to obtain an analog input signal, which is provided to the processor described in FIGS. 13 and 14.

In addition, a local oscillator (LO) generator 1540 generates transmit and receive LO and provides up converter 1512 and down converter 1525 with the transmit and receive LO, respectively.

In addition, phase locked loop (PLL) 1530 also receives control information from the processor to generate transmit and receive LO signals at appropriate frequencies and provides control signals to LO generator 1540.

Also, the circuits shown in FIG. 15 may be arranged differently from the configuration shown in FIG. 15.

FIG. 16 is a diagram illustrating still another example of an RF module of a wireless communication device to which a method proposed in this specification can be applied.

Specifically, FIG. 16 illustrates an example of an RF module that may be implemented in a time division duplex (TDD) system.

The transmitter 1610 and received 1620 of the RF module in the TDD system are identical to the structure of the transmitter and receiver of the RF module in the FDD system.

Hereinafter, the RF module of the TDD system will be described only for a structure that differs from the RF module of the FDD system, and the description of the same structure will be described with reference to FIG. 15

The signal amplified by the transmitter's power amplifier (PA) 1615 is routed through a band select switch (1650), a band pass filter (BPF) 1660, and antenna switch(es) 1670 and is transmitted through the antenna 1680.

Also, in the receive path, the antenna 1680 receives signals from the outside and provides the received signals, which signals are routed through antenna switch(es) 1670, band pass filter 1660 and band select switch 1650 and is provided to a receiver 1620.

In the aforementioned embodiments, the elements and characteristics of the present invention have been combined in specific forms. Each of the elements or characteristics may be considered to be optional unless otherwise described explicitly. Each of the elements or characteristics may be implemented in a form to be not combined with other elements or characteristics. Furthermore, some of the elements and/or the characteristics may be combined to form an embodiment of the present invention. Order of the operations described in the embodiments of the present invention may be changed. Some of the elements or characteristics of an embodiment may be included in another embodiment or may be replaced with corresponding elements or characteristics of another embodiment. It is evident that an embodiment may be constructed by combining claims not having an explicit citation relation in the claims or may be included as a new claim by amendments after filing an application.

Embodiments according to the present invention may be implemented by various means, for example, hardware, firmware, software, or a combination thereof. For implementation in hardware, an embodiment of the present invention may include one or more application specific integrated circuits (ASICs), digital signal processors (DSPs), digital signal processing devices (DSPDs), programmable logic devices (PLDs), and field programmable gate arrays (FPGAs), processors, controllers, microcontrollers, microprocessors, and the like.

In the case of an implementation by firmware or software, the embodiment of the present invention may be implemented in the form of a module, procedure or function for performing the aforementioned functions or operations. Software code may be stored in the memory and driven by the processor. The memory may be located inside or outside the processor and may exchange data with the processor through a variety of known means.

It is evident to those skilled in the art that the present invention may be materialized in other specific forms without departing from the essential characteristics of the present invention. Accordingly, the detailed description should not be construed as being limitative from all aspects, but should be construed as being illustrative. The scope of the present invention should be determined by reasonable analysis of the attached claims, and all changes within the equivalent range of the present invention are included in the scope of the present invention.

### INDUSTRIAL APPLICABILITY

An example in which the method of transmitting a V2X message in a wireless communication system of the present invention has been illustrated as being applied to the 3GPP LTE/LTE-A system, but the method may be applied to various wireless communication systems in addition to the 3GPP LTE/LTE-A system.

What is claimed is:

1. A method for resource allocation for traffic types in a wireless communication system supporting vehicle-to-everything (V2X) communication, the method performed by a base station, comprises the steps of:
setting a specific resource pool including at least one resource for each traffic type, wherein each of the plurality of traffic types differs in at least one of a transmission period and transmission time interval (TTI) length; and
transmitting the set specific resource pool to a terminal corresponding to each traffic type,
wherein the specific resource pool is set on the basis of the number of the plurality traffic types and the longest set TTI length.

2. The method of claim 1, wherein the specific resource pool includes a specific resource allocation unit to which TTIs of the same traffic type are consecutively allocated.

3. The method of claim 2, wherein the specific resource allocation unit is the same as the longest set TTI length or is a multiple of the longest set TTI length.

4. The method of claim 1, wherein when the transmission period of each of the plurality of traffic types is set differently, the specific resource pool is set in consideration of the transmission period of each traffic type.

5. The method of claim 1, wherein the size of the specific resource pool is adjusted by a parameter determined according to the frequency of traffic transmission.

6. The method of claim 1, wherein the size of the specific resource pool is the same as or greater than the total size of resources allocated to the plurality of traffic types.

7. The method of claim 1, wherein the set information for the specific resource pool includes at least one of size information of the specific resource pool, location information of the start and/or end of the specific resource pool, and information on the order of each traffic type in the specific resource pool.

8. A method for transmitting traffic in a wireless communication system supporting vehicle-to-everything (V2X) communication, the method performed by a first terminal,
receiving a specific resource pool from a base station,
wherein the specific resource pool is set to include at least one resource for each of a plurality of traffic types, and each of the plurality of traffic types differs in at least one of a transmission period or a transmission time interval (TTI) length;
determining a resource for transmitting the traffic through sensing of the specific resource pool; and
transmitting the traffic to a second terminal through the determined resource.

9. A first terminal for transmitting traffic in a wireless communication system supporting vehicle-to-everything (V2X) communication, comprising:
a radio frequency (RF) module for transmitting and receiving a radio signal;
a processor operably coupled to the RF module, wherein the processor configured to:
control receiving a specific resource pool from a base station,
wherein the specific resource pool is set to include at least one resource for each of a plurality of traffic types, and each of the plurality of traffic types differs in at least one of a transmission period or a transmission time interval (TTI) length;
control determining a resource for transmitting the traffic through sensing of the specific resource pool; and
control transmitting the traffic to a second terminal through the determined resource.
